(19) United States
(12) Patent Application Publication
(10) Pub. No.: US 2023/0102086 A1
(43) Pub. Date: Mar. 30, 2023

(54) Transmitting a Frame

(71) Applicant: Telefonaktiebolaget LM Ericsson (publ), Stockholm (SE)

(72) Inventors: Dennis Sundman, Sollentuna (SE); Miguel Lopez, Solna (SE); Sebastian Max, Cologne (DE)

(21) Appl. No.: 17/766,300

(22) PCT Filed: Oct. 8, 2019
(86) PCT No.: PCT/EP2019/077250

§ 371 Date: Apr. 4, 2022

(51) Int. Cl. H04L 1/18; H04W 74/08

(52) U.S. Cl. CPC H04L 1/1893; H04W 74/0808

(57) ABSTRACT

Methods and apparatus are provided. In an example aspect, a method in a wireless device of transmitting a frame to a receiver is provided. The method comprises determining that the frame is not successfully received by the receiver via a first wireless ommunication link between the wireless device and the receiver, and transmitting the frame to the receiver via a second wireless communication link between the wireless device and the receiver.

### TECHNICAL FIELD

Examples of the present disclosure relate to transmitting a frame to a receiver.

### BACKGROUND

In IEEE 802.11, before a wireless device (referred to in some examples as a station or STA) makes a first attempt to transmit a data frame, the STA needs to ensure that the transmission channel intended to be used is idle by performing a listen before talk (LBT) procedure. To avoid collisions with other transmissions, the STA selects a random backoff time. The STA needs to monitor an idle channel for a total duration (which may be discontinuous) as long as the backoff time before it can transmit. This backoff time is the slot size (typically 9 μs) times a random integer drawn between 0 and an initial contention window (CW). Depending on the Enhanced Distributed Channel Access (EDCA) parameters, the size of the initial CW may vary. For background data traffic, the initial CW is 2ⁿ−1 with n=4.

If the transmission of the data frame fails, such as for example due to a collision, the STA attempts a retransmission. For every attempt at retransmission, the value of n is increased with by one. Assuming background data traffic for example, this means that the CW for a first retransmission becomes 2⁵−1=31. Since the backoff parameter is the slot size times a random integer uniformly selected between 0 and CW, on average the channel access for a first retransmission will take a longer time than for a first transmission. For a second attempted retransmission, assuming that the first retransmission attempt fails, the value of n is again increased by one, such that in the example of background data traffic, the CW becomes to 2⁶−1=63. For each retransmission attempt, this procedure continues until a maximum contention window value CWₘₐₓ. For background traffic, this value is 2¹⁰−1=1023. Further details on the backoff mechanism in IEEE 802.11 can be found in section “10.3.3 Random backoff time” in IEEE Std 802.11™-2016, which is incorporated herein by reference.

### SUMMARY

One aspect of the present disclosure provides a method in a wireless device of transmitting a frame to a receiver. The method comprises determining that the frame is not successfully received by the receiver via a first wireless communication link between the wireless device and the receiver, and transmitting the frame to the receiver via a second wireless communication link between the wireless device and the receiver.

A further aspect of the present disclosure provides apparatus for transmitting a frame to a receiver. The apparatus comprises a processor and a memory. The memory contains instructions executable by the processor such that the apparatus is operable to determine that the frame is not successfully received by the receiver via a first wireless communication link between the apparatus and the receiver, and transmit the frame to the receiver via a second wireless communication link between the apparatus and the receiver.

An additional aspect of the present disclosure provides apparatus for transmitting a frame to a receiver. The apparatus is operable to determine that the frame is not successfully received by the receiver via a first wireless communication link between the apparatus and the receiver, and transmit the frame to the receiver via a second wireless communication link between the apparatus and the receiver.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method in a wireless device of transmitting a frame to a receiver; and

FIG. 2 is a schematic of an example of apparatus 200 for transmitting a frame to a receiver.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Multi-link operation is considered in development of 802.11 standards. Multi-link operation may allow multiple, simultaneous transmissions over multiple links between two devices (e.g. a transmitter and a receiver, or two wireless devices such as STAs). A link may be for example a channel, a subchannel, or a resource unit. Links may also be in different frequency bands in some examples, for example one link in the 2.4 GHz band, and another link in the 5 GHz band.

In some examples of this disclosure, a device may attempt to transmit a frame to a receiver on a first link between the device and the receiver, but the frame is not successfully received. This may be for example due to a collision, or alternatively the frame may be transmitted but no acknowledgement, or a negative acknowledgement, is returned by the receiver. The device may then transmit (or make an attempt to transmit) the frame on a second link different to the first link. The second link may be for example simultaneously active with the first link. In some examples, the frame may be transmitted (or an attempt to transmit may be commenced) before an expiry of a backoff time associated with a retransmission (or second transmission attempt) of the first frame on the first link. The links may use the same technology or standard (e.g. the same 802.11 standard) or may use different wireless communication technologies or standards in some examples.

In some examples, the device may use one link for data transfer to the receiver, and may not use the second link.

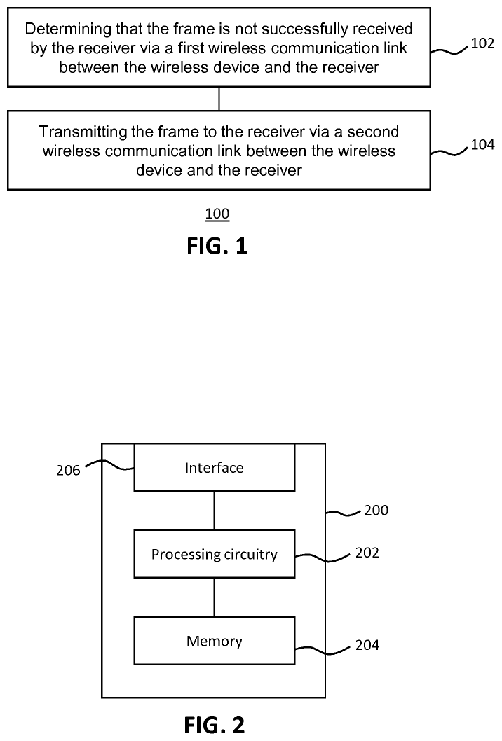

FIG. 1 is a flow chart of an example of a method 100 in a wireless device of transmitting a frame to a receiver. The method comprises, in step 102, determining that the frame is not successfully received by the receiver via a first wireless communication link between the wireless device and the receiver. This may be determined for example by determining that the frame was not transmitted by the wireless device, e.g. because of LBT failure, a number of LBT failures (e.g. in a certain time period), or some other reason. LBT failure here may mean for example that a LBT procedure indicates a collision, or that the channel is currently occupied. Alternatively, the frame may have been transmitted by the wireless device, and an acknowledgement is not received or is not successfully received (e.g. in a certain time period), or a negative acknowledgement or some other indication that the frame was not successful received at the receiver is received. In some examples, the first and second links may be 802.11 wireless communication links.

Step 104 of the method comprises transmitting the frame to the receiver via a second wireless communication link between the wireless device and the receiver. In some examples, each link between the same devices (e.g. the wireless device and the receiver) may have an independent set of EDCA parameters (which may therefore be the same or differ between links). In some examples, the links may be active (e.g. useable) simultaneously, whereas in other examples the links may not be active simultaneously (e.g. the links may require setting up or activation, for example). In some examples, the wireless device may be able to transmit simultaneously on both the first and second links. However, in other examples, the wireless device may not be able to transmit on both links simultaneously, for example due to hardware limitations (e.g. only one transmitter chain). In some examples, however, both links may be considered as being active, even if the wireless device cannot transmit simultaneously on both links. In some examples, the wireless device and receiver may both be stations or STAs.

In some examples of the method 100, the frame may be transmitted, but not acknowledged (or negatively acknowledged) by the receiver. Therefore, determining that the frame is not successfully received by the receiver may in some examples comprise transmitting the frame to the receiver using the first wireless communication link, and determining that an acknowledgement of receipt of the frame by the receiver has not been received by the wireless device. Determining that an acknowledgement has not been received may comprise determining that a negative acknowledgement (or some other indication that the frame has not been successfully received or decoded at the receiver) has been received instead. In some examples, transmitting the frame to the receiver via the second wireless communication link may comprise transmitting the frame to the receiver before expiry of a backoff time for retransmission of the frame via the first communication link following transmission of the frame using the first wireless communication link. Thus, for example, the frame can be transmitted (or an attempt can be made for transmitting the frame) on the second link with a shorter delay than if the frame is retransmitted (i.e. another attempt is made at transmission) on the first link.

In some examples, determining that the frame is not successfully received by the receiver comprises determining that a channel associated with the first wireless communication link is occupied. Thus, the frame may not be transmitted in some examples. Determining that the channel associated with the first wireless communication link is occupied may comprise performing a Listen Before Talk, LBT, procedure. In some examples, transmitting the frame to the receiver via the second wireless communication link comprises transmitting the frame to the receiver before expiry of a backoff time for a further LBT procedure on the first wireless communication link. Thus, for example, frame can be transmitted (or an attempt can be made for transmitting the frame) on the second link with a shorter delay than if the frame is retransmitted (i.e. another attempt is made at transmission) on the first link.

Transmitting the frame to the receiver via the second wireless communication link may in some examples comprises transmitting the frame to the receiver immediately on determining that the frame is not successfully received by the receiver. Thus in some examples there may be a latency reduction for retransmissions (that is, frames that were not successfully transmitted previously). In some examples, there may also be load balancing between the first and second links.

In some examples, transmitting the frame to the receiver via the second wireless communication link comprises determining that the receiver is capable of receiving frames via the first and second wireless communication links (e.g. determining that the receiver is multi-link capable). This determination may be made for example before an attempt to transmit the frame on the second communication link, and may be made for example before the second communication link is set up or activated. Whether the receiver can receive frames via both links may be determined from, for example, an association process between the wireless device and the receiver, a previous message exchange in which information relating to the receiver's capability was exchanged or an indication of the capability extracted, or a header of a frame previously received from the receiver.

In some examples, there may be three or more links between the wireless device and the receiver. In such examples, if the frame is not successfully transmitted (or received by the receiver) on the first link, the wireless device may select one of the other two links for another attempt to transmit the frame. In some examples, the second link may be chosen randomly from the other two frames (or, where there are even more links, from any of the links except the first link). In such cases, the receiver may need to monitor all of the links for the frame, or the link chosen may be communicated to the receiver by the wireless device, in some examples. Alternatively, for example, a round-robin scheme may be used to select the next link for a retransmission attempt. In such cases, the receiver may only need to monitor two links (or the receiver may not need to be informed which link(s) to monitor) as the link used as the second link may be deterministic.

In some alternatives of examples of this disclosure, the receiver may comprise two coordinated devices such as e.g. two (or more) coordinated access points. Each link may be between the wireless device and a respective one of the access points. These access points may in some examples be connected through a backhaul. In such examples, each access point may or may not be multi-link capable, as each access point may receive frames from the wireless device only on one link.

FIG. 2 is a schematic of an example of apparatus 200 for transmitting a frame to a receiver. The apparatus 200 comprises processing circuitry 202 (e.g. one or more processors) and a memory 204 in communication with the processing circuitry 202. The memory 204 contains instructions executable by the processing circuitry 202. The apparatus 200 also comprises an interface 206 in communication with the processing circuitry 202. Although the interface 206, processing circuitry 202 and memory 204 are shown connected in series, these may alternatively be interconnected in any other way, for example via a bus.

In one embodiment, the memory 204 contains instructions executable by the processing circuitry 202 such that the apparatus 200 is operable to determine that the frame is not successfully received by the receiver via a first wireless communication link between the apparatus and the receiver; and transmit the frame to the receiver via a second wireless communication link between the apparatus and the receiver. In some examples, the apparatus 200 is operable to carry out the method 100 described above with reference to FIG. 1.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1-24. (canceled)

25. A method in a wireless device of transmitting a frame to a receiver, the method comprising:
determining that the frame is not successfully received by the receiver via a first wireless communication link between the wireless device and the receiver; and
transmitting the frame to the receiver via a second wireless communication link between the wireless device and the receiver;
wherein:
determining that the frame is not successfully received by the receiver comprises transmitting the frame to the receiver using the first wireless communication link and determining that an acknowledgement of receipt of the frame by the receiver has not been received by the wireless device, and transmitting the frame to the receiver via the second wireless communication link comprises transmitting the frame to the receiver before expiry of a backoff time for retransmission of the frame via the first communication link following transmission of the frame using the first wireless communication link; or
determining that the frame is not successfully received by the receiver comprises performing a Listen Before Talk (LBT) procedure and determining that a channel associated with the first wireless communication link is occupied, and transmitting the frame to the receiver via the second wireless communication link comprises transmitting the frame to the receiver before expiry of a backoff time for a further LBT procedure on the first wireless communication link.

26. The method of claim 25, wherein transmitting the frame to the receiver via the second wireless communication link comprises transmitting the frame to the receiver immediately on determining that the frame is not successfully received by the receiver.

27. The method of claim 25, wherein transmitting the frame to the receiver via the second wireless communication link comprises performing a LBT procedure on the second wireless communication link.

28. The method of claim 25, wherein transmitting the frame to the receiver via the second wireless communication link comprises determining that the receiver is capable of receiving frames via the first and second wireless communication links.

29. The method of claim 25, wherein the first and second wireless communication links comprise 802.11 wireless communication links.

30. A non-transitory computer-readable medium comprising, stored thereupon, a computer program comprising instructions configured to, when the computer program instructions are executed on at least one processor of a wireless device, cause the at least one processor to:
determine that a transmitted frame is not successfully received by a receiver via a first wireless communication link between the wireless device and the receiver; and
transmit the frame to the receiver via a second wireless communication link between the wireless device and the receiver;
wherein:
determining that the frame is not successfully received by the receiver comprises transmitting the frame to the receiver using the first wireless communication link and determining that an acknowledgement of receipt of the frame by the receiver has not been received by the wireless device, and transmitting the frame to the receiver via the second wireless communication link comprises transmitting the frame to the receiver before expiry of a backoff time for retransmission of the frame via the first communication link following transmission of the frame using the first wireless communication link; or
determining that the frame is not successfully received by the receiver comprises performing a Listen Before Talk (LBT) procedure and determining that a channel associated with the first wireless communication link is occupied, and transmitting the frame to the receiver via the second wireless communication link comprises transmitting the frame to the receiver before expiry of a backoff time for a further LBT procedure on the first wireless communication link.

31. An apparatus for transmitting a frame to a receiver, the apparatus comprising a processor and a memory, the memory containing instructions executable by the processor such that the apparatus is operable to:
determine that the frame is not successfully received by the receiver via a first wireless communication link between the apparatus and the receiver; and
transmit the frame to the receiver via a second wireless communication link between the apparatus and the receiver;
wherein the memory contains instructions executable by the processor such that the apparatus is operable to:
determine that the frame is not successfully received by the receiver by transmitting the frame to the receiver using the first wireless communication link and determining that an acknowledgement of receipt of the frame by the receiver has not been received by the wireless device, and transmit the frame to the receiver via the second wireless communication link by transmitting the frame to the receiver before expiry of a backoff time for retransmission of the frame via the first communication link following transmission of the frame using the first wireless communication link; or
determine that the frame is not successfully received by the receiver by performing a Listen Before Talk (LBT) procedure and determining that a channel associated with the first wireless communication link is occupied, and transmit the frame to the receiver via the second wireless communication link by transmitting the frame to the receiver before expiry of a backoff time for a further LBT procedure on the first wireless communication link.

32. The apparatus of claim 31, wherein the memory contains instructions executable by the processor such that the apparatus is operable to transmit the frame to the receiver via the second wireless communication link by transmitting the frame to the receiver immediately on determining that the frame is not successfully received by the receiver.

33. The apparatus of claim 31, wherein the memory contains instructions executable by the processor such that the apparatus is operable to transmit the frame to the receiver via the second wireless communication link by performing a LBT procedure on the second wireless communication link.

34. The apparatus of claim 31, wherein the memory contains instructions executable by the processor such that the apparatus is operable to transmit the frame to the receiver via the second wireless communication link by determining that the receiver is capable of receiving frames via the first and second wireless communication links.

35. The apparatus of claim 31, wherein the first and second wireless communication links comprise 802.11 wireless communication links.
